(19) United States
(12) Patent Application Publication
(10) Pub. No.: US 2017/0010816 A1
(43) Pub. Date: Jan. 12, 2017

(54) PROVIDING COMBINED DATA FROM A CACHE AND A STORAGE DEVICE

(71) Applicant: HEWLETT PACKARD ENTERPRISE DEVELOPMENTT LP, Houston, TX (US)

(72) Inventors: Qiming Chen, Cupertino, CA (US); Maria G. Castellanos, Sunnyvale, CA (US); Meichun Hsu, Los Altos Hills, CA (US)

(21) Appl. No.: 15/114,261

(22) PCT Filed: Apr. 18, 2014
(86) PCT No.: PCT/US2014/034647

§ 371 Date: Jul. 26, 2016

(51) Int. Cl. G06F 3/06; G06F 12/0804; G06F 17/30

(52) U.S. Cl. CPC G06F 3/0604; G06F 17/30516; G06F 17/30339; G06F 12/0804; G06F 3/0629; G06F 3/0659; G06F 3/068; G06F 2212/163

(57) ABSTRACT

Methods, apparatus, systems and articles of manufacture are disclosed to manage a cache. An example method includes in response to receiving a request to retrieve received data, retrieving first data from a cache, the first data received during a first time period, and retrieving, second data from a storage device, the second data received during a second time period prior to the first time period; and providing the first data and second data as combined data the, combined data being combined based on the first time period and the second period.

### BACKGROUND

It any applications analyze streaming data from sensors, mobile devices, social media, etc. for analysis and/or processing. For example, such data may be used to ascertain business intelligence, statistics, etc. Often times, most recently received data is the most frequently demanded as it may provide the most up-to-date information.

### BRIEF DESCRIPTION OF THE DRAWINGS

FIG. 1 is a block diagram of an example processor system including an example event pipe manager implemented in accordance with the teachings of this disclosure.

FIG. 2 illustrates an example event pipe manager that may be used to implement the event pipe manager of FIG. 1.

FIG. 3 is an example data flow diagram illustrating in an example flow of data managed by the event pipe manager of FIGS. 1 and/or 2.

FIG. 4 is a flowchart representative of example machine readable instructions that may be executed to implement the example event pipe manager of FIGS. 1 and/or 2 to retrieve and/or provide event data.

FIG. 5 is a flowchart representative of other example machine readable instructions that may be executed to implement the example event pipe manager of FIGS. 1 and/or 2 to retrieve and/or provide event data.

FIG. 6 is a flowchart representative of example machine readable instructions that may be executed to implement the example event pipe manager of FIGS. 1 and/or 2 to analyze received data.

### DETAILED DESCRIPTION

Example methods, apparatus, and articles of manufacture are disclosed herein for a cache event manager. Examples disclosed herein involve managing receipt, analysis, and access to event data using event pipes in a cache and corresponding data tables in main memory. Examples disclosed herein enable access to event data buffered in a cache to enable access to most recently received event data in real-time. Accordingly, instant or near instant access is available to data received at a system before the data is written to main memory of the system using the examples disclosed herein.

A central processing unit (CPU) cache locally stores data from a main memory (e.g., a volatile memory device, a non-volatile memory device, etc.). In some examples, a cache is used in a processor platform to increase speed of data operations because storing data to a cache is faster than writing data to main memory. Accordingly, a cache may act as a buffer for received data to allow time for the CPU and/or a memory controller to write the received data to main memory. For example, a central processing unit (CPU) of a processor platform stores received/retrieved data (e.g., event data representative of real-time messages, real-time events, real-time social media messages, etc.) from a device and/or network in communication with the processor platform and stores the received data in the cache (e.g., in an event pipe, etc.) until the data is written by the CPU and/or memory controller to the main memory.

In some examples, data in a cache line or cache pipe is written to main memory on an individual basis (e.g., based on first-in first-out (FIFO), a priority basis, etc.) as soon as the CPU and/or memory controller is available to write a cache line to the main memory. In some examples, the CPU and/or memory controller perform(s) bulk inserts, which, as used herein, involve periodically or aperiodically writing all data from the cache to main memory. Accordingly, in such examples, a time delay exists between when data is received at the processor platform and when the data may be accessible for retrieval from main memory.

Continuously collected event data can provide advantages for gaining business intelligence through analysis of the events represented by the event data. In many instances, most recently received data (e.g., approximately the most recently received 1% of data) can be the most frequently (e.g., approximately 99% of the time) demanded data. Accordingly, having the ability to access most recently received event data from a cache and/or corresponding event data in a storage device or database can be advantageous in providing the most accurate analytics and analysis of the corresponding events.

An example method disclosed herein includes, in response to receiving a request to retrieve data received at a server, retrieving first data from a cache and retrieving second data from a storage device, in which the first data was received during a first time period and the second data was received during a second time period prior to the first time period. Further the example method includes providing the first data and the second data as combined data based on the first time period and the second time period. In some examples, an example event pipe stores the first data in the cache and an example data table stores the second data in the storage device (e.g., a database, main memory, etc.). Examples disclosed herein involve identifying a schema associated with event data and generating a pipe scan function corresponding to the first event pipe based on the schema to enable access to and/or retrieve data from an event pipe of a cache.

An example apparatus disclosed herein includes an event analyzer to sort event data received at a server into a corresponding event pipe in a cache associated with the server. Further the apparatus includes a data retriever to retrieve cached event data from the event pipe and stored event data from a data table of a non-volatile memory associated with the server, in which the data table corresponds to the event pipe based on a schema of the cached event data and the stored event data. The example data retriever may combine the cached event data and stored event data to create combined event data and an example event pipe interface of the example apparatus may provide the combined event data in response to the request for the event data.

Examples disclosed herein involve buffering event data in an event pipe, of a cache that is identified by an event pipe and shifting the event data from the event pipe to a data table of a storage device after the event data is buffered in the cache for a period of time. Some examples further involve buffering the retrieved second data from the cache and the data stored in the data table and providing the data and the second data as combined data.

As used herein, “event data” is representative of data associated with events (e.g., social media posts, sensor data, data from mobile devices, etc.) from a received data stream or flow of data, “pipe data” includes event data that is stored in an event pipe of a cache, and “table data” includes event data that s stored in a data table (e.g., a database) of main memory. As used herein, a pipe or event pipe is a designated data structure (e.g., a queue, buffer, cache line, etc.) of a cache that stores, at least temporarily, data anchor event data. Example event data, example pipe data, and/or example table data may include data from a plurality of events. For example an event pipe may include event data identifying several social media posts, sensor measurements, etc.

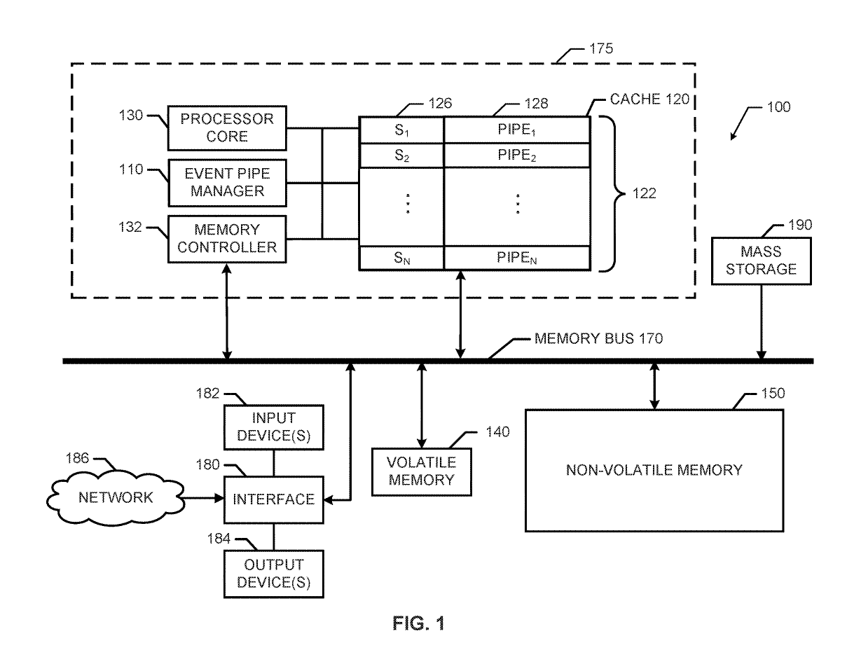

FIG. 1 is a block diagram of an example processor system 100 including an example event pipe manager 110 implemented in accordance with the teachings of this disclosure. The processor system 100 may be a server (e.g., a web service server), a computer, or any other type of computing device. The processor system 100 also includes a cache 120, a processor core 130 (or a central processing unit (CPU)), a memory controller 132, a volatile memory 140, and a non-volatile memory 150. In the illustrated example of FIG. 1, a memory bus 170 facilitates communication between the cache 120, the memory controller 132, the volatile memory 140, and the non-volatile memory 150. The processor core 130 of the illustrated example of FIG. 1 is hardware. For example, the processor core 130 can be implemented by at least one of integrated circuits, logic circuits, microprocessors or controllers from any desired family or manufacturer.

The volatile memory 140 of the illustrated example of FIG. 1 is any volatile memory storage device that stores data when powered, but loses memory state when power is removed. For example, the volatile memory 140 may be implemented by Synchronous Dynamic Random Access Memory (SDRAM), Dynamic Random Access Memory (DRAM), Static Random Access Memory (SRAM), RAMBUS Dynamic Random Access Memory (RDRAM) and/or any other type of volatile memory. The non-volatile memory 150 of FIG. 1 is any non-volatile memory storage device (e.g., phase-change memory, memristor memory, flash memory, etc.) that is capable of storing data when powered and when not powered.

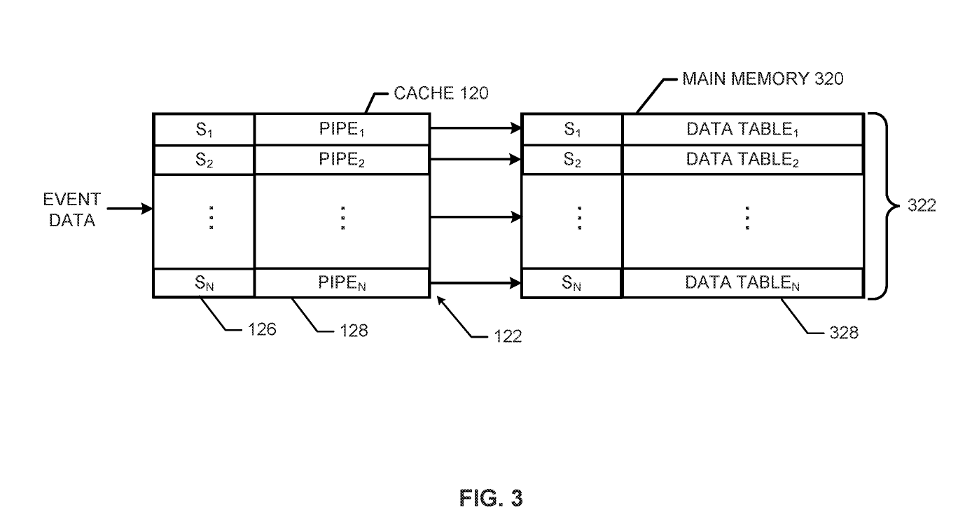

The example cache 120 in FIG. 1 is a local storage circuit that may be collocated on a same device 175 (e.g., a semiconductor chip) as the processor core 130, the memory controller 132, and/or the event pipe manager 110. In the illustrated example of FIG. 1, the processor core 130 can perform faster read and/or write operations when accessing data in the cache 120 than when, accessing data in the volatile memory 140 and/or in the non-volatile memory 150 via the memory bus 170. Accordingly, the event pipe manager 110, the processor core 130, and/or the memory controller 132 may load data received at the processor platform 100 into the cache 120 so that the processor core 130 can access and/or process the received data relatively quickly using the cache 120. In some examples, the cache 120 acts as a buffer to temporarily store, data (e.g., event data) received at the processor platform 100 prior to the data being stored in main memory (e.g., see FIG. 3).

The event pipe manager 110 in the illustrated example of FIG. 1 manages event data received at the processor platform 100. As used herein, event data is data (e.g., streamed data, social media posts, sensor data, device data, etc.) that is stored and/or buffered in event pipes 122 as pipe data in the cache 120 and/or is stored in corresponding data tables as table data in main memory (e.g. the volatile memory 140 and/or the non-volatile memory 150). The example cache 120 may be comprised partially or entirely of event pipes 122. In some examples, the event pipe manager 110 may be implemented via the memory controller 132 and/or managed by the memory controller 132. The event pipe manager 110 and/or the memory controller 132 of the illustrated example of FIG. 1 may implement different techniques to determine a duration that data remains in the cache 120. For example, the event pipe manager 110 may manage the length of time (e.g., a threshold period of time, such as five minutes, 10 minutes, etc.) that data in the event pipes 122 remain in the corresponding event pipes 122. In some examples, the event pipe manager 110 and/or the memory controller 132 write(s) data (e.g., copies data) from the cache 120 (e.g., from an event pipe 122) to the volatile memory 140 and/or the non-volatile memory 150 before the data is removed from the cache 120. For example, the event pipe manager 110 may copy event data from an event pipe 122 to a corresponding data table of the non-volatile memory 150 after the event data is buffered in the cache 120 for a first period of time (e.g., 1 minute). In such an example, the event pipe manager 110 may then remove the event data from the event pipe 122 after being buffered for a second period of time (e.g., 5 minutes). Accordingly, in this example, multiple instances of the event data exist in both the event pipe 122 of the cache 120 and a corresponding data table of the non-volatile memory 150.

The example cache 120 of FIG. 1 includes N event pipes 122. Each event pipeᵢ 122 includes an example schema (Sᵢ) 126 (where I identifies a particular event pipe 122) and example pipe dataᵢ 128. As used herein for readability, example event pipe₁ 122 has a schema S₁ 126 and pipe data₁ 128, example event pipe₂ 122 has a schema S₂ 126 and pipe data₂ 128, and so on. An example timestamp may be included with the pipe dataᵢ 128 to indicate a time that the corresponding pipe dataᵢ 128 was received (e.g., by the processor system 100, event pipe manager 110, memory controller 132, etc.) and/or stored in the cache 120. The schema Sᵢ 126 of FIG. 1 may be an identifier (e.g., an indicator identifying a characteristic such as a name, user name, account, format, protocol, address, etc.) corresponding to the pipe data 128. In the illustrated example, the event pipe manager 110 manages the event data cached (buffered) in each event pipeᵢ 122 based on the schema Sᵢ 126 and/or timestamps corresponding to the pipe data 128, as described herein. For example, event data having schema S₁ may be loaded into corresponding event pipe₁ 122 in a queue (i.e., chronologically).

The example event pipes 122 store event data 128 for a corresponding flow of data (e.g., streaming data) having a schema Sᵢ 126. For example, a first event pipe₁ 122 may correspond to a social network feed of a particular user, group, category, etc. (e.g., “tweets” from a Twitter® account, posts from a Facebook® account, etc.). In such an example, the schema S₁ 126 may represent at least one of a username, a social network type, a message format, etc. of the social network feed and the pipe data₁ 128 may be the data contents (e.g., text data, image data, video data, audio data, etc.) of the social network feed. In some examples, the event data may be data streamed from sensors or other devices that provide information for analytics, intelligence, etc.

As disclosed herein, the event pipe manager 110 of FIG. 1 may be implemented via hardware, software, and/or firmware. The example event pipe manager 110 controls and/or performs operations (e.g., read and write) using event data (e.g., pipe dataᵢ 128) that is stored in the event pipes 122 and/or data tables in main memory (e.g., as table data in the non-volatile memory 140 and/or non-volatile memory 150) in accordance with this disclosure. More specifically, examples disclosed herein enable the event pipe manager 110 to retrieve data from the event pipes 122 and/or analyze data to be stored in the event pipes 122.

The example processor platform 100 of the illustrated example of FIG. 1 further includes an interface circuit 180. The interface circuit 180 may be implemented by any type of interface standard, such as an Ethernet interface, a universal serial bus (USB), and/or a Peripheral Component Interconnect (PCI) express interface.

In the illustrated example of FIG. 1, at least one input device(s) 182 is(are) connected to the interface circuit 180. The input device(s) 182 permit(s) a user to enter data and/or commands into the processor core 130. As described herein, a user may request event data from the cache and/or main memory via the input device(s) 182. The input device(s) 182 can be implemented by, for example, an audio sensor, a microphone, a camera (still or video), a keyboard, a button, a mouse, a touchscreen, a track-pad, a trackball, ISO-point and/or a voice recognition system.

At least one output device(s) 184 is(are) also connected to the interface circuit 180 of the illustrated example. The output devices 184 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 180 of the illustrated example, thus, typically includes a graphics driver card, a graphics driver chip or a graphics driver processor.

The interface circuit 180 of the illustrated example also includes a communication device such as a transmitter, a receiver, a transceiver, a modem and/or network interface card to facilitate exchange of data with external machines (e.g., computing devices of any kind) via a network 186 (e.g., an Ethernet connection, a digital subscriber line (DSL), a telephone line, coaxial cable, a cellular telephone system, etc.).

The processor platform 100 of the illustrated example also includes at least one mass storage device 190 for storing software and/or data. Examples of such mass storage devices 190 include floppy disk drives, hard drive disks, compact disk drives, Blu-ray® disk drives, RAID systems, and digital versatile disk (DVD) drives. In some examples, the mass storage devices 190 may be implemented using the non-volatile memory 150.

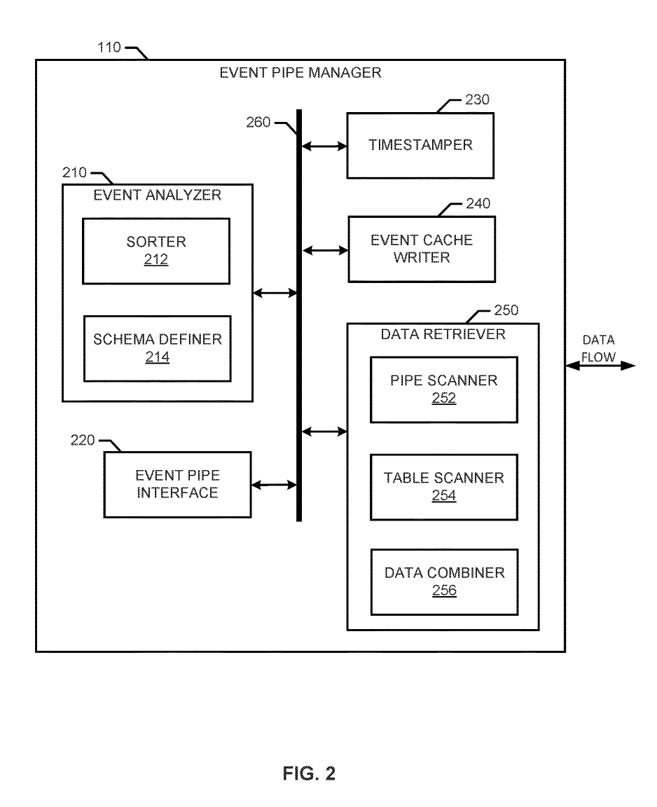

FIG. 2 illustrates an example event pipe manager 110 that may be used to implement the event pipe manager 110 of FIG. 1. The event pipe manager 110 includes an event analyzer 210 having a sorter 212 and a schema definer 214. The example event pipe manager 110 further includes an example event pipe interface 220, an example timestamper 230, an example event cache writer 240, and an example data retriever 250. The data retriever 250 includes an example pipe scanner 252, an example table scanner 254, and an example data combiner 256. In the illustrated example of FIG. 2, a communication bus 260 facilitates communication between the event analyzer 210, the event pipe interface 220, the timestamper 230, the event cache writer 240, and the data retriever 250.

The event pipe manager 110 of the illustrated example of FIG. 2 analyzes data to/from and/or through the example processor platform 100 of FIG. 1. When event data is received at the example processor platform 100, such as from the network 186, the example sorter 212 of the event pipe analyzer 210 identifies a schema (e.g., using information in a packet header, such as metadata, name, format, protocol, etc.) of the event data and determines a corresponding event pipe 122 in the cache 120 to which the event data is to be cached. The example sorter 212 forwards the event data to the cache 120 to be cached and/or buffered in the determined event pipe 122.

described herein, example schema Sᵢ (e.g., schema S₁, S₂ . . . S_{N} 126) may he defined and/or identified based on user preferences and/or settings. For example, a user may specify at least one characteristic(s) of event data that is(are) to be used to define and/or identify schema Sᵢ of the event data. Example characteristics of the data include data profile information (e.g., user name, user demographics, metadata, etc.) and/or data type (e.g., data format, data protocol, etc.). In some examples, when event data is received, the event analyzer 210 instructs the schema definer 214 to generate a schema corresponding to the event data. The schema definer 214 forwards the generated schema Sᵢ to the cache 120 to create a new event pipe 122, to the pipe scanner 252 to generate a new pipe scan function (e.g., a user defined function (UDF)), and to-main memory (e.g., the main memory 320 of FIG. 3) to generate a new data table (see FIG. 3). Accordingly, a new event pipe 122, pipe scan function, and data table are generated for data having the same schema.

In some examples, the sorter 212 of FIG. 2 identifies a schema Sᵢ of the event data and sorts the event data into the corresponding event pipeᵢ 122 based on the schema Sᵢ. In some examples, when the sorter 212 does not identify a particular schema S_{new} of the event data corresponding to an event pipeᵢ 122 in the cache 120, the sorter 212 loads the data into a new event pipe_{new} 122 of the cache 120 that is created based on the schema S_{new}.

The example event pipe interface 220 of FIG. 2, which may be implemented by an application programming interface (API), enables user control and/or communication (e.g., via the interface 180 of FIG. 1) with the event pipe manager 110 of FIG. 2. As described herein, the event pipe interface 220 receives user requests for event data (e.g., structured query language (SQL) queries from the input device(s) 182) in the cache 120 and/or main memory of the processor system 100. The pipe interface 220 forwards such requests to the data retriever 250. The pipe interface 220 provides the corresponding event data to the user (e.g., via the output device(s) 184) upon receipt from the data retriever 250. In some examples, the event pipe interface 220 may be implemented via the interface circuit 180, the input device(s) 182, and/or the output device(s) 184.

The example time stamper 230 timestamps received event data. For example, the timestamper 230 may timestamp the event data based on when the event data is received at the processor platform 110, based on when the event data is analyzed by the event pipe manager 110, and/or based on when the event data is stored in an event pipeᵢ 122 of the cache 120. In some examples, timing information is included in the event data indicating a time of an event corresponding to the event data (e.g., when the event was created, posted to an account, etc.). In such examples, the timestamper 230 may timestamp the event data with the corresponding time indicated in the timing information. As described herein, the data retriever 250 refers to the timestamp to identify data received and/or created during a designated time period (e.g., a time period specified in user request for data).

The event cache writer 240 of the illustrated example of FIG. 2 writes event data from the cache 120 to corresponding event tables in main memory. As illustrated in the data flow 300 of FIG. 3, event data is stored in corresponding event pipes of the cache 120 and pipe data 128 from the event pipes 122 is forwarded to corresponding data tables 322 (e.g., databases) in main memory 320. The example main memory 320 may be implemented by at least one of the volatile memory 140, the non-volatile memory 150, and/or the mass storage 190 of FIG. 1. The example cache writer 240 writes (e.g., writes a copy) and/or shifts (e.g., writes a copy and removes) the pipe dataᵢ 128 from an event pipeᵢ 122 of the cache 120 to a corresponding data tableᵢ 322 of the main memory 320 based on the schema Sᵢ to be stored as table dataᵢ 328. In other words, in the illustrated example of FIG. 3, the cache event writer 240 identifies the schema Sᵢ of the event pipeᵢ 122 and/or pipe dataᵢ 128 and stores (e.g., writes, shifts, etc.) the pipe dataᵢ 128 in the data tableᵢ 322 having the same schema Sᵢ to create the table data 128.

In some examples, the event cache writer 240 of FIG. 2 performs a bulk insert and writes all or a portion of the event data 128 from the event pipes 122 of the cache to the corresponding data tables 322 in the main memory 320. In some examples, the event cache writer 240 derives a SQL insert from the schema defined by the schema definer 214 to perform the bulk insert. For example, the event cache w r 240 may write pipe data 128 periodically (e.g., every 5 minutes, every minute, etc.) or when an amount of event data 128 stored in the cache 120 reaches a threshold (e.g., a percentage capacity of the cache 120). In some examples, the event cache writer 240 may write event data 128 from each event pipeᵢ 122 at different rates. For example, the event cache writer 240 may write first pipe data₁ 128 from the first event pipe₁ 122 to a corresponding data table₁ 322 in the main memory 320 every minute and write coed pipe data₂ 128 from a second event pipe₂ 122 to a corresponding data table₂ in the main memory 320 every two minutes.

In some examples, the event cache writer 240 monitors corresponding settings for each pipeᵢ 122 in the cache 120. Such example settings may include granule (e.g., 1 minute), start-time, end-time (e.g., the most recent time timestamp), etc. of a class of the event pipeᵢ 122. In some examples, the event data is written to the main memory after a first period of time (e.g., 1 minute) and removed from the cache 120 after a second period of time (e.g., 5 minutes). In other words, pipe data 128 from an event pipe is copied to the main memory 320 before the pipe data 128 is removed from the cache 120. Accordingly, multiple instances of the event data of an event pipeᵢ 122 may exist in an event pipeᵢ 122 of the cache 120 and a corresponding data tableᵢ 322 of the main memory 320. The event cache writer 240 then writes or shifts the pipe data to the main memory 320 based on the settings for each individual pipe 122.

In response to data requests received via the event pipe interface 220, the example data retriever 250 of FIG. 2 retrieves and provides corresponding event data to the event pipe interface (e.g., for presentation to a user). For example, a request for data retrieval may identify a schema Sᵢ, characteristic of a schema Sᵢ and/or a period of time associated with the data having the schema Sᵢ. In some examples, the period of time may include a most recent period of time (e.g., the minute, the last 5 minutes, the last hour, the last 8 hours, etc.). In such examples, the data retriever 250 is capable of retrieving data from the cache 120 in addition to the main memory 320.

The example data retriever 250 uses the pipe scanner 252 to retrieve data from data pipes 122 in the cache 120. The example pipe scanner 252 uses schema information from the schema definer 214 to generate a pipe scan function (e.g., a UDF) from the schema Sᵢ for a corresponding event pipeᵢ 122. The example pipe scan function retrieves event data from the corresponding event pipeᵢ 122. In some examples, the pipe scan function acts as a web service and retrieves the event data using a hypertext transfer protocol (HTTP). Accordingly, using the event pipe interface 220 (e.g., an application programming interface), a user, via the pipe scan function, is able to access (e.g., request/receive event data) the event pipes 122 of the cache 120.

The data retriever 250 of the illustrated example of FIG. 2 uses the table scanner 254 to access table data 328 from the main memory 320. The example table scanner 254 retrieves data from the data tables 322 having a schema Sᵢ corresponding to the schema of the event pipe 122 from the data tables 322 using any suitable data retrieval techniques for accessing data from a database, storage device, etc.

The example data combiner 256 of FIG. 2 combines event data retrieved from an event pipeᵢ 122 by the pipe scanner 252 and event data retrieved from a corresponding data table 322 by the table scanner 254. In some examples, the data combiner 256 compares pipe dataᵢ 128 retrieved from an event pipe 122 and table data 328 retrieved from a data tableᵢ 322 to determine whether there is an overlap in the event data. In other words, the data combiner 256 determines whether pipe dataᵢ 128 from the event pipeᵢ 122 matches table dataᵢ 328 from the data tableᵢ 322. The data combiner 256 accounts for the overlap by providing the data as combined data. The example combined data only includes one instance of the overlap data (i.e., multiple copies of matching data is not provided). In other words, the example data combiner 256 determines a logical union of the event data in the pipe dataᵢ 122 and the table dataᵢ 128. Accordingly, the example data combiner 256 may combine data from the event pipes 122 and the data tables 322 to present a block of event data having a schema Sᵢ that was received during a period of time that includes a most recent period of time. In such examples, the example event pipe manager 110 is capable of providing real-time data by having the ability to access the cache 120 and/or the main memory 320 to retrieve event data in response to a request for event data that was received during a period of time that includes a most recent period of time.

In the illustrated example of FIG. 2, the example event pipe interface 220 receives event data from the event pipes 122 and/or data tables 322. The example event data may be received as combined data (e.g., a union of data) having a given schema Sᵢ from both an event pipeᵢ 122 and the corresponding data tableᵢ 322 based on a request from a user for event data received during a time period that is longer than the time period that data is stored in the cache 120. In some examples, if the time period identified in a request for data is less than a time period during which event data is stored in the cache 120, the example data my only be data from an event pipe 122. The example event pipe interface 220 provides the requested data (e.g., as combined data, as a union of the pipe dataᵢ 128 and the table dataᵢ 328, etc.) to the user, for example using the output devices) 184 of FIG. 1. Accordingly, in response to a user requesting data having an identified schema Sᵢ, the example event pipe manager 110 can retrieve the corresponding data from both the event pipeᵢ 122 and/or data tableᵢ 322 and provide the example data to the user via the event pipe interface 220.

While an example manner of implementing the event pipe manager 110 of FIG. 1 is illustrated in FIG. 2, at least one of the elements, processes and/or devices illustrated in FIG. 2 may be combined, divided, rearranged, omitted, eliminated and/or implemented in any other way. Further, the example event analyzer, including the example sorter 212 and/or the example schema definer 214, the example event pipe interface 220, the example timestamper 230, the example event cache writer 240, the example data retriever 250, including the example pipe, scanner 252, the example table scanner 254, and/or the example data combiner 256, and/or, more generally, the example event pipe manager 110 of FIG. 2 may be implemented by hardware, software, firmware and/or any combination of hardware, software and/or firmware. Thus, for example, any of the example event analyzer, including the example sorter 212 and/or the example schema definer 214, the example event, pipe interface 220, the example timestamper 230, the example event cache writer 240, the example data retriever 250, including the example pipe scanner 252, the example table scanner 254, and/or the example data combiner 256, and/or, more generally, the example event pipe manager 110 could be implemented by at least one analog or digital circuit(s), logic circuit(s), programmable processor(s), application specific integrated circuit(s) (ASICs)), programmable logic device(s) (PLD(s)) and/or field programmable logic device(s) (FPLD(s)). When reading any of the apparatus or system claims of this patent to cover a purely software and/or firmware implementation, at least one of the example event analyzer, including the example sorter 212 and/or the example schema definer 214, the example event pipe interface 220, the example timestamper 230, the example event cache writer 240, the example data retriever 250, including the example pipe scanner, the example table scanner 254, and/or the example data combiner 256 is/are hereby expressly defined to include a tangible computer readable storage device or storage disk such as a memory, a digital versatile disk (DVD), a compact disk (CD), a Blu-ray disk, etc. storing the software and/or firmware. Further still, the example event pipe manager 110 of FIG. 2 may include at least one element(s), process(es) and/or device(s) in addition to or instead of, those illustrated in FIG. 2, and/or may include more than one of any or all of the illustrated elements, processes and devices.

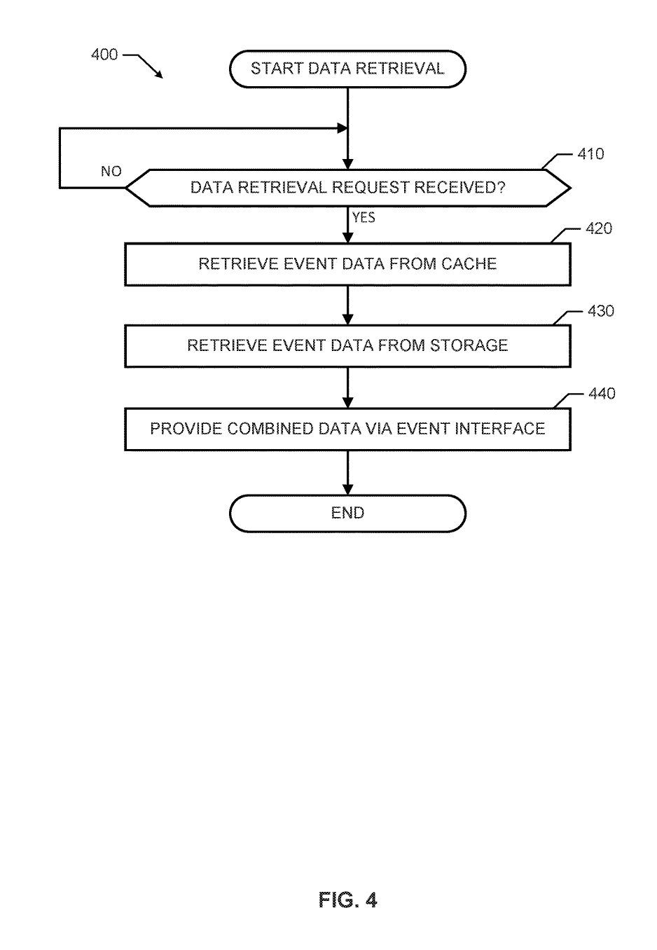

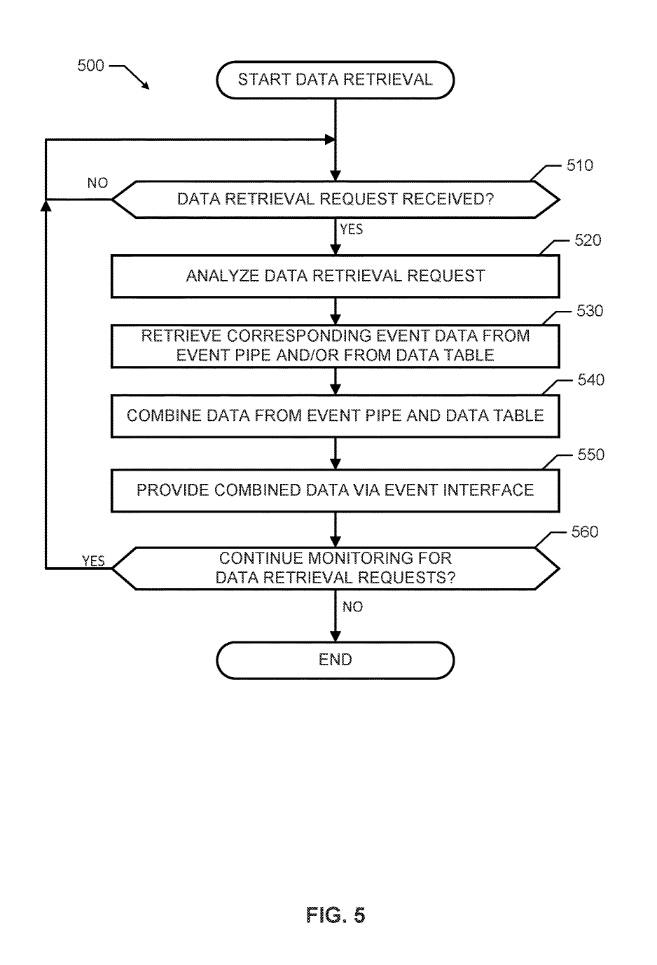

Flowcharts representative of example machine readable instructions for implementing the event pipe manager 110 of FIG. 2 are shown in FIGS. 4, 5, and/or 6. In this example, the machine readable instructions comprise a program for execution by a processor such as the processor 112 shown in the example processor platform 100 discussed below in connection with FIG. 1. The program may be embodied in software stored on a tangible computer readable storage medium such as a CD-ROM, a floppy disk, a hard drive, a digital versatile disk (DVD), a Blu-ray disk, or a memory associated with the processor 112, but the entire program and/or parts thereof could alternatively be executed by a device other than the processor 112 and/or embodied in firmware or dedicated hardware. Further, although the example program is described with reference to the flowcharts illustrated in FIGS. 4, 5, and/or 6, many other methods of implementing the example event pipe manager 110 may alternatively be used. For example, the order of execution of the blocks in each of the FIGS. 4, 5, and/or 6 may be changed, and/or some of the blocks described may be changed, eliminated, or combined.

The program 400 of FIG. 4 begins with an initiation of the event pipe manager 110 of FIGS. 1 and/or 2 to monitor for data retrieval requests (e.g., upon start of the processor platform 100, upon receiving instructions from a user, etc.). At block 410, the example event pipe manager 110 monitors for data retrieval requests (e.g., an SQL query). For example, the event pipe manager 110 may monitor the interface 180 and/or input devices 182 for data retrieval requests via the event pipe interface 220. If no data retrieval request is received at block 410, the event pipe manager 110 continues to monitor for data retrieval requests (control returns to block 410). If a data retrieval request is received at block 410 of FIG. 4, control advances to block 420.

At block 420 of the illustrated example of FIG. 4, the data retriever 250 retrieves data from a cache. For example, at block 420, the pipe scanner 252 of the data retriever 250 executes a pipe scan function to retrieve first data from the cache 120. At block 430, the data retriever 250 retrieves event data from a storage (e.g., a storage device, a main memo including a volatile memory and/or a non-volatile memory, etc.). For example, at block 430, the table scanner 254 of the data retriever 250 may retrieve second data from a data table in the non-volatile memory 150 of FIG. 1.

At block 440 of FIG. 4, the data retriever 250, via the event pipe interface 220, provides the data from the cache 120 and the storage device as combined data. For example, the data combiner 256 of the data retriever 250 may perform a logical union of the data retrieved from the cache 120 and the storage device. Accordingly, after the data retriever 250 provides (e.g., to a user or requester of the data retrieval request in 410) the combined data, the program 400 ends.

The program 500 of FIG. 5 begins with an initiation of the event pipe manager 110 of FIGS. 1 and/or 2 to monitor for data retrieval requests (e.g., upon start of the processor platform 100, upon receiving instructions from a user, etc.). At block 510, the example event pipe manager 110 monitors for data retrieval requests (e.g., an SQL query). If no data retrieval request is received, the event pipe manager 110 continues to monitor for data retrieval requests (control returns to block 510). If a data retrieval request is received, control advances to block 520. At block 520, the event pipe interface 220 analyzes the received data retrieval request. For example, at block 520, the event pipe interface 220 identifies a schema corresponding to the requested data, a time period associated with the requested data (e.g., when the requested data was received, sent, etc.), etc. Based on the analysis of the data retrieval request, the example event pipe interface 220 instructs the data retriever 250 to retrieve corresponding event data (e.g., pipe data 128 and/or table data 328) from the corresponding event pipe 122 and/or from the corresponding data table 322. In other words, the event pipe interface 220 provides the schema and/or time period identified in the data retrieval request. The pipe scanner 252 retrieves data from the event cache 120 if a corresponding event pipe 122 includes data received during a time period included in the time period identified in the data retrieval request (block 530). Additionally or alternatively, the table scanner 254 retrieves data from the main memory 320 if a corresponding data table 322 includes data associated with (e.g., received during, posted during, created during, etc.) a time period included in the time period identified in the data retrieval request (block 530). In such examples, the pipe scanner 252 and/or the table scanner 254 may refer to timestamps associated with the event data in the event pipe 122 and/or data table 322.

At block 540 of the illustrated example of FIG. 5, the data combiner 256 of the data retriever 250 combines data from the corresponding event pipe 122 and the corresponding data table 322 to generate combined data such that all data having a requested schema and received during a requested period is determined and provided. As described herein, the data combiner 256 identifies overlap data between event data in the event pipe 122 and event data in the data table 322. The data retriever 250 provides the retrieved data as combined data via the event pipe interface 220 to a user (e.g., via a display of the output device(s) 184) at block 550. For example, at block 550, the combined data may be provided as a list of chronologically ordered event data received during a time period. As a more detailed example, the combined data in block 550 may include social media posts of a user received at the processor platform 100 within a most recent time period and stored in an event pipe 122 of the cache 120 and social media posts from the same user received during a time period adjacent to the most recent time period and stored in the a data table 322 of the main memory 320. In such an example, a request for such data may identify the user and the time period (e.g., from 8:00 AM to 5:00 PM, the last 8 hours, etc.), which includes the most recent time period (e.g., from 4:55 PM to 5:00 PM, the last 5 minutes, etc.) and the time period adjacent the most recent time period (e.g., 8:00 AM to 4:55 PM, the 7 hours and 55 minutes prior to the last 5 minutes, etc.).

At block 560, the event pipe manager 110 determines whether to continue monitoring for data retrieval requests. If the event pipe manager 110 is to continue monitoring for data retrieval requests, control returns to block 510. If, at block 560, the event pipe manager 110 is not to continue monitoring for data requests (e.g., due to a shutdown, power failure, instructions from user, etc.), the program 500 ends.

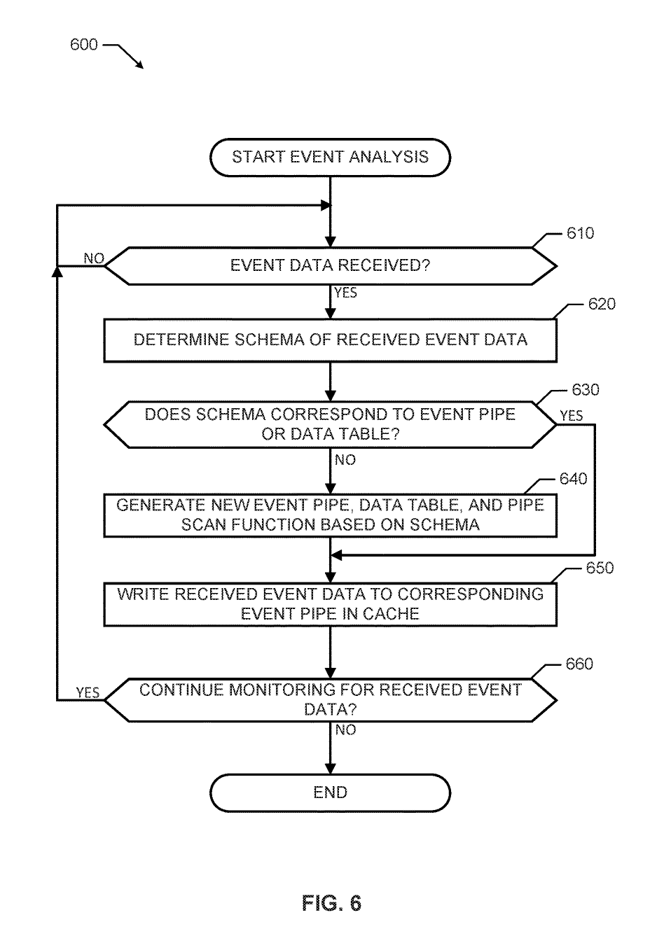

The program 600 of FIG. 6 begins with an initiation of the event pipe manager 110 to monitor for received event data (e.g., upon start of the processor platform 100, upon receiving instructions from a user, etc.). The example program 600 may be executed simultaneously with the programs 400, 500, prior to the programs 400, 500 or after the programs 400, 500 of FIGS. 4 and/or 5. At block 610, the event analyzer 210 of the event pipe manager 110 monitors for received event data. If the event analyzer 210 determines that no event data has been received, the event analyzer 210 continues to monitor for received event data (block 610). If, at block 610, the event analyzer 210 determines that event data has been received, the event analyzer 210 analyzes the received data to determine a schema of the received event data (block 620). In some examples, at block 620, the event analyzer 210 may identify a schema associated with the event data (e.g., the schema is identified in a header of the event data). Additionally or alternatively, at block 620, the event analyzer 210 may generate a schema from the event data and/or information associated with the event data (e.g., header information, metadata, user information, format, etc.).

At block 630 of the example program 600 of FIG. 6, the event analyzer 210 determines whether the determined schema from block 620 corresponds to a schema of an event pipe 122 in the cache 120 and/or to a schema of a data table 322 in the main memory 330. If, at block 630, the sorter 212 determines that the determined schema does not correspond to a schema in an event pipe 122 or a data table 322, the example schema definer 214 generates, based on the determined schema, a new event pipe 122 in the cache 120, a new data table 322 in the main memory 320, and a new pipe scan function to identify and/or retrieve the event data from the new event pipe 122 (block 640). If, at block 630, the example sorter 214 does determine that the determined schema corresponds to an event pipe in the cache 120 and/or a data table 322 in the main memory 320, control advances to block 650. After block 630 and/or block 640, the example sorter 212 writes the received event data to the corresponding event pipe 122 in the cache 120.

At block 660 of FIG. 6, the example event pipe manager 110 determines whether it is to continue to monitor for received event data. If, at block 660, the event pipe manager 110 determines that it is to continue to monitor for received data, control returns to block 610. If, at block 660, the event pipe manager 110 determines that is not to continue to monitor for received data, the program 600 ends.

As mentioned above, the example processes of FIGS. 4 and/or 5 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 4 and/or 5 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

From the foregoing, it will be appreciated that the above disclosed methods, apparatus and articles of manufacture enable real-time retrieval of event data from an event pipe of a cache and/or a data table from main memory. Examples disclosed herein involve generating an example event pipe, a pipe scan function, and/or a data table based on a schema associated with event data. In response to receiving a data retrieval request for event data having the example schema, data received during a most recent time period is retrieved from an event pipe in a cache and data received prior to the most recent time period may be retrieved from the data table. The event data from the event pipe and the event data from the data table can be combined and provided as combined data representative of data received during a designated time period.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method comprising:
in response to receiving a request to retrieve data received at a server,
retrieving first data from a cache, the first data received during a first time period, and
retrieving second data from a storage device, the second data received during a second time period prior to the first time period; and
providing the first data and second data as combined data, the combined data being combined based on the first time period and the second period.

2. The method of claim 1, wherein the first data is stored in a first pipe of the cache and the second data is stored in a first data table of the storage device, the first pipe of the cache corresponding to the first data table of the storage device based on a characteristic of the first and second data.

3. The method of claim 2, wherein the first data table comprises data previously stored in the that pipe.

4. The method of claim 1, further comprising:
determining first overlap data in the first data that matches second overlap data in the second data; and
identifying a timestamp corresponding to the least recently received data in the overlap data,
wherein the retrieved second data comprises data received at the server prior to a time represented by the timestamp.

5. The method of claim 1, wherein the first data is stored in a first event pipe of the cache, the method further comprising:
identifying a first schema of the first data; and
generating a pipe scan function corresponding to the first event pipe based on the first schema, the pipe scan function to be used to retrieve the first data.

6. An apparatus comprising:
an event analyzer to sort event data received at a server into a corresponding event pipe in a cache associated with the server;
a data retriever to:
retrieve cached event data from the event pipe and stored event data from a data table of a non-volatile memory associated with the server, the data table corresponding to the event pipe based on a schema of the cached event data and the stored event data, and
combine the cached event data and stored event data to create combined event data; and
an event pipe interface to provide the combined vent data in response to a request for event data.

7. The apparatus of claim 6, wherein the cached event data comprises a mo recently received data comprising the schema.

8. The apparatus of claim 6, wherein the stored event data comprises previously buffered data in the event pipe.

9, The apparatus of claim 6, wherein the cached event data was received during a most recent time period and the stored event data was received during an adjacent time period prior to the most recent time period.

10. The apparatus of claim 9, wherein the request identifies an event data time period comprising the adjacent time period and the most recent time period.

11. The apparatus of claim 6, further comprising an event cache writer to write the cached event data to the data table after the cached event data is stored in the cache for a period of time.

12. The apparatus of claim 6, wherein the data retriever retrieves the event cache data from the event pipe via hypertext transfer protocol (HTTP).

13. A non-transitory computer readable storage medium comprising instructions that, when executed, cause a machine to at least:
buffer received first event data in an event pipe of a cache, the event pipe identified by a schema;
shift the first event data from the event pipe to a data table of a storage device after the event data is buffered in the cache for a period of time, the data table identified by the schema;
buffer received second event data in the event pipe, the second event data associated with the schema;
retrieve the second event data from the event pipe and the first event data from the data table; and
provide the second event data and the first event data as combined data.

14. The non-transitory computer readable storage medium of claim 13, wherein the instructions, when executed, cause the machine to:
associate a first timestamp with the first data;
associate a second timestamp with the second data; and
provide the first event data and the second event data based on the first timestamp and the second timestamp.

15. The non-transitory computer readable storage medium of claim 13, wherein the second event data is more recently received than the first event data.
